(19) United States
(12) Patent Application Publication
(10) Pub. No.: US 2026/0005275 A1
(43) Pub. Date: Jan. 1, 2026

(54) FUEL CELL SYSTEM AND METHOD OF OPERATION

(71) Applicant: MAHLE International GmbH, Stuttgart (DE)

(72) Inventor: Markus Auer, Stuttgart (DE)

(21) Appl. No.: 18/879,749

(22) PCT Filed: Jun. 28, 2023
(86) PCT No.: PCT/EP2023/067704

§ 371 Date: Dec. 27, 2024

(30) Foreign Application Priority Data
Jun. 30, 2022 (DE) 10 2022 206 676.6

(51) Int. Cl. H01M 8/04746; B60K 13/04; F02C 6/20; H01M 8/04119; H01M 8/04225; H01M 8/04302

(52) U.S. Cl. CPC H01M 8/04761; B60K 13/04; F02C 6/20; H01M 8/04156; H01M 8/04225; H01M 8/04302; H01M 2250/20; H01M 2250/402

(57) ABSTRACT

A fuel cell system for a motor vehicle is disclosed. The fuel cell system includes an expansion engine having a high-pressure side and a low-pressure side for performing mechanical work. A plurality of fuel cells are stacked on top of one another, which communicate fluidically with the high-pressure side of the expansion engine via a gas path. A water separator is arranged in the gas path for separating water from the exhaust gas. A valve unit is arranged between the water separator and the high-pressure side of the expansion engine for adjusting an amount of exhaust gas to be supplied to the expansion engine. A bypass-gas path through which the exhaust gas can flow, which branches off from the gas path between the plurality of fuel cells and the water separator. A bypass-valve unit arranged in the bypass-gas path.

### CROSS-REFERENCE TO RELATED APPLICATIONS

This application claims priority to International Patent Application No. PCT/EP2023/067704 filed Jun. 28, 2023, which also claims priority to German Patent Application No. DE 10 2022 206 676.6 filed Jun. 30, 2022, the contents of each of which is hereby incorporated by reference in its entirety.

### TECHNICAL FIELD

The present invention relates to a fuel cell system and a method for operating such a fuel cell system.

### BACKGROUND

The use of fuel cells in motor vehicles is well known and is becoming increasingly important. A fuel cell system usually consists of several fuel cells stacked on top of each other. A stack of this kind, made up of fuel cells, is often also referred to as a “stack”. During operation, the individual fuel cells produce a water-containing exhaust gas, which is removed from the stack by means of an exhaust system. An expansion engine is typically arranged in the exhaust system's exhaust gas line, which can be driven by the exhaust gas and in this way performs mechanical work.

To prevent damage to the expansion engine by the water contained in the exhaust gas, it is common practice to install a water separator in the exhaust gas system upstream of the expansion engine. This must be designed in such a way that it can remove water from the exhaust gas even during a cold start of the fuel cell system, when a particularly large amount of water is produced. However, a water separator designed in this way not only causes a relatively high pressure drop in the exhaust gas system during cold starts, but also during normal operation of the fuel cell system, which increases the consumption of the fuel cell system and thus reduces its efficiency.

It is therefore one of the objectives of the present invention to create an improved design for a fuel cell system in which the aforementioned problem is addressed.

This object is achieved by the scope of the independent claim(s). Preferred embodiments are the scope of the dependent claims.

### SUMMARY

The basic idea of the invention is therefore to equip the exhaust system of a fuel cell system with a bypass, by means of which the exhaust gas—in particular during the aforementioned cold start of the fuel cell system—can be diverted past the expansion engine, so that there is no risk of damage to the expansion engine from water present in the exhaust gas. The bypass in question branches off from the exhaust gas system not only upstream of the expansion engine, but also upstream of the water separator. This means that the water separator can be designed to be less powerful because it only has to separate water from the exhaust gas during nominal operation, but not during cold starts. However, such an interpretation of the water separator is favorably accompanied by lower pressure losses, which in turn leads to improved efficiency of the fuel cell system.

To control the bypass and thus the amount of exhaust gas to be routed past the expansion engine, a valve is provided both in the actual exhaust gas system and in the bypass. These valves can be used to adjust the proportion of exhaust gas to be fed to the expansion engine and the proportion to be routed past the expansion engine via the bypass. This ratio can be adjusted to individual operating situations while the fuel cell system is in operation. This applies in particular to the cold start of the fuel cell system, in which it is possible to temporarily bypass the exhaust gas completely via the bypass by closing the valve assigned to the expansion engine.

Both the valve assembly and the bypass-valve unit can be of a conventional design, which means that they comprise a valve opening provided in the gas path and the bypass-gas path, respectively, which is bordered by a valve seat. Furthermore, the valve system or bypass valve system includes an adjustable valve body that, in a closed position, rests against the valve seat and closes the valve opening in a fluid-tight manner so that no exhaust gas can flow through the valve opening. In an open position other than the closed position, however, the valve opening is open for the exhaust gas to flow through. Furthermore, the valve unit or bypass-valve unit can be designed so that the valve body can be adjusted to intermediate positions between the open position and the closed position. In particular, the opening cross-section of the valve opening that is released for the exhaust gas to flow through can be increased by moving the valve body from the closed position to the open position. In this way, the degree of opening of the valve unit or the bypass-valve unit can be varied.

In detail, a fuel cell system according to the invention comprises an expansion engine for performing mechanical work, which has a high-pressure side and a low-pressure side. Furthermore, the fuel cell system comprises several fuel cells, i.e. at least two, stacked on top of each other. These fuel cells communicate fluidically with the high-pressure side of the expansion engine via a gas path, so that when the fuel cell system is in operation, the exhaust gas expelled from the fuel cells into the gas path and containing water when expelled drives the expansion engine. The gas path can be part of an exhaust system or an exhaust gas line of the fuel cell system.

Furthermore, the fuel cell system includes a water separator arranged in the gas path to separate water from the exhaust gas. A valve unit of the fuel cell system for adjusting the amount of exhaust gas to be supplied to the expansion engine is arranged between the water separator and the high-pressure side of the expansion engine.

According to the invention, the fuel cell system also includes a bypass-gas path through which the exhaust gas can flow. This bypass-gas path branches off between the fuel cells and the water separator from the gas path, so that the exhaust gas can be routed past the expansion engine via the bypass-gas path. The bypass-gas path can rejoin the gas path downstream of the expansion engine. A bypass-valve unit of the fuel cell system for adjusting the amount of exhaust gas flowing through the bypass-gas path is arranged in the bypass-gas path.

A gas turbine can be used as the expansion engine. Preferably, the expansion engine or the gas turbine comprises a rotatable turbine wheel that can be driven by the exhaust gas.

The valve unit arranged in the gas path may preferably be or include a pressure control valve for controlling the gas pressure of the exhaust gas. In particular, the pressure control valve can be configured so that the pressure in the cathode of the fuel cells is regulated to a specific setpoint by adjusting the pressure control valve accordingly.

Also preferably, the bypass-valve unit located in the bypass-gas path can be or include a pressure control valve. This pressure control valve can also be configured in such a way that the pressure in the cathode of the fuel cells is regulated to a specific setpoint by adjusting the pressure control valve accordingly.

The valve unit and the bypass-valve unit can be designed as common parts that are particularly suitable for this purpose. This property simplifies the design of the fuel cell system and thus leads to cost advantages in the production of the fuel cell system.

According to a favorable training, the fuel cell system comprises a control/regulator device, by means of which the valve means and the bypass valve means can each be adjusted between an open position, in which the exhaust gas can flow through the valve means, and a closed position, in which the flow of exhaust gas is prevented. Using a control/regulator device configured in this way, the position of the valve unit can be adapted to different operating situations. This makes it possible to determine which part of the exhaust gas coming from the fuel cells is fed to the expansion engine and which part is directed past the expansion engine. In particular, it is possible to operate the fuel cell system in different operating states. In particular, this allows for the fact that the exhaust gas contains a particularly large amount of water when the fuel cells are cold-started, which can thus be routed past the expansion engine via the bypass to protect the expansion engine.

In a further preferred embodiment, the fuel cell system according to the invention can be switched between a nominal operating state and a cold start operating state by means of the control/regulator device. In this embodiment, the valve unit is not adjusted to the closed position in nominal operating state. This means that the valve is moved to the open position or to an intermediate position between the closed and open position. This means that a certain amount of exhaust gas can always enter the expansion engine and drive it, with the water separator being able to separate the water contained in the exhaust gas so that it cannot enter the expansion engine. In the cold start operating state, the bypass valve is not adjusted to the closed position. This means that at least part of the exhaust gas is routed past the expansion engine. This prevents the water separator from being overloaded due to the increased amount of water in the exhaust gas.

According to a favorable training, in the cold start mode, the valve unit is adjusted to the closed position. This provides the best possible protection for the expansion engine against damage caused by water during a cold start.

According to a further advantageous training, in the nominal operating state, the bypass valve means is adjusted to the closed position. This ensures that all exhaust gas is fed to the expansion engine, maximizing the efficiency of the fuel cell system.

The invention also relates to a motor vehicle with a fuel cell system according to the invention presented above, so that the advantages of the fuel cell system according to the invention are transferred to the motor vehicle according to the invention.

The invention also relates to a method of operating a fuel cell system as presented above, with a control and regulation system, so that the advantages of the fuel cell system according to the invention are also transferred to the method according to the invention. According to the method, the fuel cell system is first switched to the cold start operating state after it is put into operation, i.e. after it is switched on, and is operated in this cold start operating state and switched from the cold start operating state to the nominal operating state at a later point in time.

Further important features and advantages of the invention can be seen from the subclaims, from the drawing, and from the associated description of the figures with reference to the drawing.

It is understood that the features mentioned above and those to be explained below can be used not only in the respective combination given, but also in other combinations or on their own, without departing from the scope of the present invention.

### BRIEF DESCRIPTION OF THE DRAWINGS

Preferred exemplary embodiments of the invention are shown in the drawings and are explained in more detail in the following description, where the same reference signs refer to the same or similar or functionally identical components.

FIG. 1 shows schematically a fuel cell system according to an example.

### DETAILED DESCRIPTION

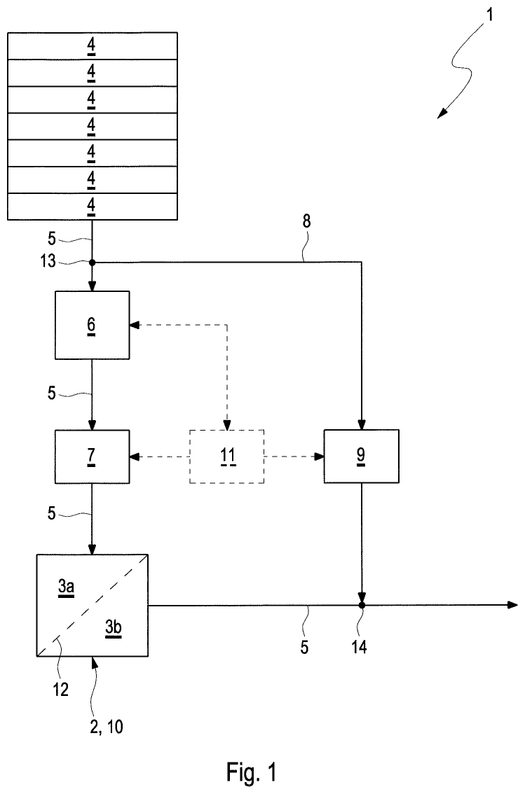

FIG. 1 schematically shows an example of a fuel cell system 1 according to the invention. This includes an expansion engine 2 for performing mechanical work, which has a high-pressure side 3a and a low-pressure side 3b. In the example scenario, the expansion engine 2 is a gas turbine 10. The expansion engine 2 or the gas turbine 10 may comprise a rotatable turbine wheel (not shown, indicated in FIG. 1 by a dashed line 12) that can be driven by the exhaust gas, which divides the expansion engine 2 or the gas turbine 10 into the high-pressure side 3a and the low-pressure side 3b.

Fuel cell system 1 also includes several fuel cells 4 that are stacked on top of one another and communicate fluidically with the high-pressure side 3a of the expansion engine 2 via a gas path 5. Thus, during operation of the fuel cell system 1, exhaust gas expelled from the fuel cells 4 into the gas path 5 can drive the expansion engine 2. Water is contained in the exhaust gas. Therefore, a water separator 6 is provided in the gas path 5 to separate the water from the exhaust gas before it reaches the expansion engine 2. Furthermore, the fuel cell system 1 comprises a bypass-gas path 8 through which the exhaust gas can flow, which branches off from the gas path 5 between the fuel cells 4 and the water separator 6 at a branch point 13, passes the expansion engine 2 and opens into the gas path 5 again downstream of the expansion engine 2 at a junction point 14. Exhaust gas can therefore be routed past the expansion engine 2 via the bypass-gas path 8. A valve unit 7 for adjusting the amount of exhaust gas to be supplied to the expansion engine 2 is arranged in the gas path 5 between the water separator 6 and the high-pressure side 3a of the expansion engine 2. In a similar way, a bypass-valve unit 9 for adjusting the amount of exhaust gas flowing through the bypass-gas path 8 and thus being routed past the expansion engine 2 is arranged in the bypass-gas path 8.

The valve unit 7 arranged in gas path 5 is formed by a pressure control valve. Likewise, the bypass-valve unit 9 arranged in the bypass-gas path 8 can be formed by a pressure control valve. The valve unit 7 and the bypass-valve unit 9 or the two pressure control valves can be designed as identical parts.

Fuel cell system 1 also includes a control and regulator device 11. The control/regulator device 11 can be used to adjust both the valve unit 7 arranged in the gas path 5 and the bypass-valve unit 9 arranged in the bypass-gas path 8 between an open position and a closed position. In the open position, exhaust gas can flow through the valve assembly 7 or the bypass-valve unit 9. In the closed position, however, the flow of exhaust gas through the valve unit 7 or the bypass-valve unit 9 is prevented. The valve mechanism 7 and the bypass valve mechanism 9 can each also be adjusted to intermediate positions between the open position and the closed position.

Fuel cell system 1 can be switched between a nominal operating state and a cold start operating state by means of the control/regulator device 11. In the cold start operating state, the valve unit 7 is adjusted to the closed position, in the nominal operating state to a position other than the closed position. This position, which is different from the closed position, can be the open position. In nominal operating mode, the bypass-valve unit 9 is adjusted to the closed position, and in cold start operating mode, it is adjusted to a position other than the closed position. This position, which is different from the closed position, can be the open position.

The method according to the invention can be carried out in the fuel cell system 1 explained by way of example above. According to the method, the fuel cell system 1 is first switched to the cold start operating state after it is put into operation, i.e. after it is switched on, and is operated in this cold start operating state, and is switched from the cold start operating state to the nominal operating state at a later point in time.

1. A fuel cell system for a motor vehicle, comprising:
an expansion engine having a high-pressure side and a low-pressure side for performing mechanical work,
a plurality of fuel cells stacked on top of one another, the plurality of fuel cells communicate fluidically with the high-pressure side of the expansion engine via a gas path, so that during operation, water-containing exhaust gas expelled from the plurality of fuel cells into the gas path drives the expansion engine,
a water separator arranged in the gas path for separating water from the exhaust gas,
a valve unit arranged between the water separator and the high-pressure side of the expansion engine for adjusting an amount of exhaust gas to be supplied to the expansion engine,
a bypass-gas path through which the exhaust gas can flow, the bypass-gas path branches off from the gas path between the plurality of fuel cells and the water separator and via which exhaust gas can be routed past the expansion engine, and
a bypass-valve unit arranged in the bypass-gas path for adjusting the amount of exhaust gas flowing through the bypass-gas path.

2. The fuel cell system according to claim 1, wherein the expansion engine is a gas turbine.

3. The fuel cell system according to claim 1, wherein the valve unit arranged in the gas path is or comprises a pressure control valve.

4. The fuel cell system according to claim 1, wherein the bypass-valve unit arranged in the bypass-gas path is or comprises a pressure control valve.

5. The fuel cell system according to claim 1, wherein the valve unit and the bypass-valve unit are structured as non-variable parts.

6. The fuel cell system according to claim 1, further comprising a control/regulator device, via which the valve unit and the bypass-valve unit can each be adjusted between an open position, where the exhaust gas can flow through the valve unit, and a closed position, where the flow of exhaust gas is prevented.

7. The fuel cell system according to claim 6, wherein:
the fuel cell system can be switched over via the control/regulator device between a nominal operating state and a cold start operating state, and
wherein in nominal operating state the valve unit is not adjusted to the closed position and in cold start operating state the bypass valve unit is not adjusted to the closed position.

8. The fuel cell system according to claim 7, wherein in the cold start operating state, the valve unit is adjusted to the closed position.

9. The fuel cell system according to claim 7, wherein in cold start operating mode, the bypass valve is not adjusted to the closed position.

10. The fuel cell system according to claim, wherein in the nominal operating state, the bypass valve is adjusted to the closed position.

11. A motor vehicle, comprising: a fuel cell system, the fuel cell system including;
an expansion engine having a high-pressure side and a low-pressure side for performing mechanical work,
a plurality of fuel cells stacked on top of one another, the plurality of fuel cells communicate fluidically with the high-pressure side of the expansion engine via a gas path, so that during operation of the fuel cell system, water-containing exhaust gas expelled from the plurality of fuel cells into the gas path drives the expansion engine,
a water separator arranged in the gas path for separating water from the exhaust gas,
a valve unit arranged between the water separator and the high-pressure side of the expansion engine for adjusting an amount of exhaust gas to be supplied to the expansion engine,
a bypass-gas path through which the exhaust gas can flow, the bypass-gas path branches off from the gas path between the plurality of fuel cells and the water separator and via which exhaust gas can be routed past the expansion engine, and
a bypass-valve system arranged in the bypass-gas path for adjusting the amount of exhaust gas flowing through the bypass-gas path.

12. A method for operating a fuel cell system according to claim 7, according to which the fuel cell system is switched to the cold start operating state after commissioning and is switched from the cold start operating state to the nominal operating state at a later point in time.

13. The motor vehicle according to claim 11, wherein the expansion engine is a gas turbine.

14. The motor vehicle according to claim 11, wherein the valve unit arranged in the gas path is or comprises a pressure control valve.

15. The motor vehicle according to claim 11, wherein the bypass-valve unit arranged in the bypass-gas path is or comprises a pressure control valve.

16. The motor vehicle according to claim 11, wherein the valve unit and the bypass-valve unit are structured as non-variable parts.

17. The motor vehicle according to claim 11, further comprising a control/regulator device.

18. The motor vehicle according to claim 17, wherein via the control/regulator device the valve unit and the bypass-valve unit can each be adjusted between an open position, where the exhaust gas can flow through the valve unit, and a closed position, where the flow of exhaust gas is prevented.

19. The motor vehicle according to claim 18, wherein:
the fuel cell system can be switched over via the control/regulator device between a nominal operating state and a cold start operating state, and
in nominal operating state the valve unit is not adjusted to the closed position and in cold start operating state the bypass valve unit is not adjusted to the closed position.

20. The motor vehicle according to claim 19, wherein:
in the cold start operating state, the valve unit is adjusted to the closed position;
in the cold start operating state, the bypass valve is not adjusted to the closed position; and
in the nominal operating state, the bypass valve is adjusted to the closed position.
